(19) United States
(12) Patent Application Publication
(10) Pub. No.: US 2014/0319351 A1
(43) Pub. Date: Oct. 30, 2014

(54) INSPECTION APPARATUS AND AN INSPECTION METHOD

(71) Applicant: Sumitomo Electric Industries, Ltd., Osaka-shi (JP)

(72) Inventors: Eiichiro YAMADA, Yokohama-shi (JP); Akinori KIMURA, Yokohama-shi (JP)

(73) Assignee: Sumitomo Electric Industries, Ltd., Osaka-shi (JP)

(21) Appl. No.: 14/260,063

(22) Filed: Apr. 23, 2014

(30) Foreign Application Priority Data
Apr. 25, 2013 (JP) 2013-092784

(51) Int. Cl. G01J 1/42; G01N 21/88

(52) U.S. Cl. CPC G01J 1/42; G01N 21/8851
USPC 250/339.02

(57) ABSTRACT

Detection of articles of different kind or defective quality can be accomplished with higher accuracy. With an inspection apparatus 100 and an inspection method using the inspection apparatus 100, in an analyzing unit 30, first, target pixels having imaged inspection objects are extracted from spectral data of each pixel acquired in a detecting unit 20, and the spectral data of plural target pixels which have imaged the same inspection object are grouped beforehand, and the classification of inspection objects is performed using the thus grouped spectra of the target objects. Therefore, the classification of inspection objects is done using the spectral data of a plurality of target pixels which have imaged the same inspection object. This enables reducing the possibility of incorrect judgment due to a noise contained in a specific pixel. Thus, the detection of articles of different kind or defective quality can be accomplished with higher accuracy.

### FIELD OF THE INVENTION

The present invention relates to inspection apparatus and an inspection method, and particularly to those suitable for detecting an article of different kind or defective quality among a plurality of inspection objects of the same form.

### DESCRIPTION OF THE BACKGROUND ART

A detector for detecting an article of different kind or defective quality among inspection objects flowing on a processing line is known. For example, WO2005/038443 (Patent document 1) discloses a detector having a structure in which near-infrared light is irradiated to inspection objects and after the spectroscopy of light reflected from the inspection objects is performed to form a two-dimensional image, the spectral data of the reflected light is obtained by capturing the two-dimensional image, and a different kind of object is detected on the basis of analysis of the spectral data of the reflected light according to a principal component analysis.

In the case of detecting a foreign substance or defective article using the principal component analysis of Patent document 1, analysis is conducted by determining the principal component so that the dispersion of each plot which constitutes a spectrum may become the maximum. Therefore, when the measurement is performed under the conditions where the ratio of noise components is high and differences of a spectrum of foreign substances or defective articles relative to a spectrum of principal components is small, the performance of detecting foreign substances or defective articles will decrease because the principal component is determined using the small spectral differences.

### SUMMARY OF THE INVENTION

### Object of the Invention

The object of the present invention is to provide detection equipment and method for detecting an article of different kind or defective quality with higher accuracy.

### Means for Achieving the Object

To achieve the above-mentioned object, provided is an inspection apparatus for classifying inspection objects in an image capturing area, comprising: a light source for emitting near-infrared light to the image capturing area; dispersing means for dispersing the light incident from the image capturing area when the near-infrared light is emitted; imaging means for outputting spectral data of each pixel by capturing a spectral image consisting of a plurality of pixels of light dispersed by the dispersing means; pixel extraction means for extracting, on the basis of the spectral data of each pixel, a target pixel to be analyzed from a plurality of pixels; spectrum calculation means for calculating the spectrum of inspection objects on the basis of spectral data of target pixels classified as belonging to a group formed by grouping a plurality of target pixels lying adjacent to each other; and a classifying means for classifying inspection objects on the basis of the spectrum computed by the spectrum calculation means.

As another aspect of the invention, provided is an inspection method, comprising: a dispersing step of dispersing the light incident from the image capturing area to which near-infrared light is emitted by a light source; an imaging step of outputting spectral data of each pixel by capturing a spectral image consisting of a plurality of pixels of light dispersed at the dispersing step; a pixel extraction step of extracting, on the basis of the spectral data of each pixel, a target pixel to be analyzed from a plurality of pixels; a spectrum calculation step of calculating the spectrum of inspection objects on the basis of spectral data of target pixels belonging to a group of pixels as a result of grouping a plurality of target pixels lying adjacent to each other; and a classifying step of classifying inspection objects on the basis of the spectrum computed by the spectrum calculation step.

### Effect of the Invention

According to the present invention, it is possible to provide a detection apparatus and a detection method for detecting an article of different kind or defective quality with higher accuracy.

### BRIEF DESCRIPTION OF DRAWINGS

FIG. 1 is a conceptual diagram showing the composition of the inspection apparatus relating to an embodiment of the present invention.

FIG. 2 is a conceptual diagram explaining a hyper-spectral image detected with the inspection apparatus of FIG. 1.

FIG. 3 is a flow chart of the inspection method relating to the embodiment of the present invention.

FIG. 4 is a conceptual diagram explaining a first example of grouping of target pixels.

FIG. 5 is a conceptual diagram explaining a second example of grouping of target pixels.

FIG. 6 is a conceptual diagram explaining a third example of grouping of target pixels.

FIG. 7 is a graph showing an example of result of PCA analysis.

FIG. 8 is a graph showing an example of result of PCA analysis.

FIG. 9 is a graph showing an example of result of PCA analysis.

### DETAILED DESCRIPTION OF THE INVENTION

Hereinafter, embodiments of the present invention will be explained with reference to the drawings. A drawing is provided for the purpose of illustration of the invention and not intended to limit the scope thereof. The ratio of dimensions in the drawing is not necessarily exact.

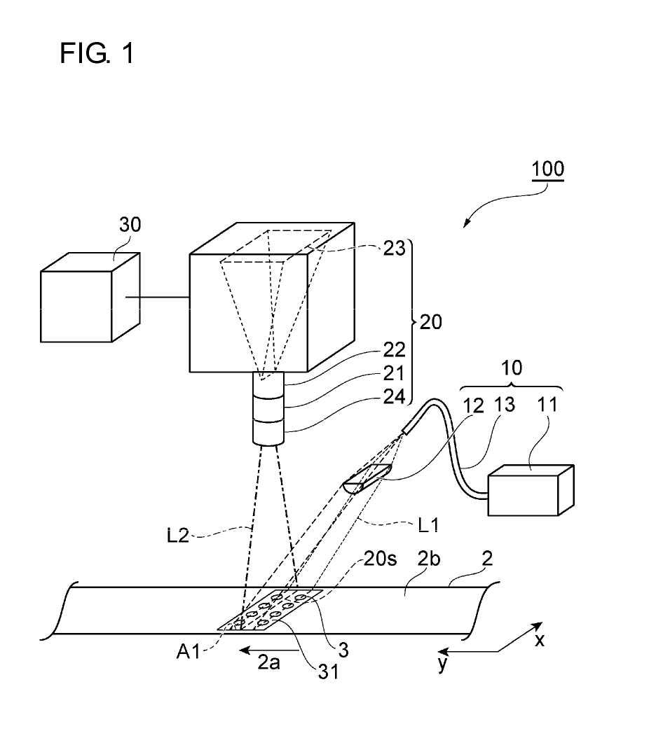

FIG. 1 is a conceptual diagram showing the composition of an inspection apparatus 100 relating to an embodiment of the present invention. The inspection apparatus 100 is primarily intended for inspecting articles of different kind or defective quality mixed in the inspection objects 3 dispersedly placed on a belt conveyor 2.

Examples of inspection objects 3 include raw materials and products of food or medical goods, etc. In particular, the inspection apparatus 100 is suitable for inspecting whether articles of different kind or defective quality are mixed in the inspection objects 3 which have a uniform shape and size. For example, the inspection objects may be drugs (uncoated tablets, sugar-coated pills, film-coated tablets such as enteric coated tablets, hard capsules, soft capsule, etc.), rubber plugs, foods, or drinks contained in a container. The term “articles of defective quality” as used herein does not mean defective articles in terms of shape such as partial breakage, but means those which suffer from change in physical properties, for example, due to oxidization or moisture absorption, etc. Moreover, the inspection apparatus 100 is suitable for 100% in-line inspection of inspection objects which are under conveyance. In the following description, an explanation will be given with respect to the case where inspection is performed to examine whether any tablets of different kind or defective quality are mixed in the inspection objects 3 which are tablets put in a carrying container 31.

The inspection apparatus 100 measures the spectrum of diffuse reflection light obtained by irradiating near-infrared measurement light to inspection objects 3, and inspects the inspection objects 3 on the basis of the spectrum. Therefore, the inspection apparatus 100 has a light source unit 10, a detecting unit 20 (imaging means), and an analyzing unit 30 (a pixel extraction means, a spectrum calculation means, and a classifying means).

The light source unit 10 irradiates the near-infrared measurement light towards a predetermined irradiation domain A1 on a belt conveyor 2. The wavelength range of the measurement light irradiated by the light source unit 10 is suitably chosen depending on the inspection objects 3. When the inspection objects are tablets, the wavelength range of 800 nm to 2500 nm is suitable for the measurement light, and particularly the light of 1000 nm to 2300 nm is more suitable. In this embodiment, explanation will be given about the light source unit 10 including a halogen lamp light source 11.

The irradiation domain A1 is a region on the surface (loading side 2b) of the belt conveyor 2 on which the inspection objects 3 are placed. The irradiation domain A1 is an area which extends in the width direction (the x-axis direction) perpendicular to the moving direction 2a (the y-axis direction) of the loading side 2b of the belt conveyor and which extends in the longitudinal direction, covering from one end to the other end of the loading side 2b. And the width of the irradiation domain A1 in the direction (the y-axis direction) perpendicular to the longitudinal direction of the irradiation domain A1 is set to be narrower than the x-axis direction.

The light source unit 10 has a halogen lamp light source 11, an illuminating section 12, and an optical fiber 13 for connecting the light source 11 and the illuminating section 12. The light source 11 generates near-infrared light. The near-infrared light generated by the light source 11 is made incident to one end face of the optical fiber 13. This near-infrared light travels through the core region of the optical fiber 1 and is emitted from the other end to the illuminating section 12.

The illuminating section 12 irradiates the near-infrared light emitted from the end side of the optical fiber 13 to the irradiation domain A1 on which the inspection objects 3 are placed. A cylindrical lens is suitably used in the illuminating section 12 so that the near-infrared light emitted from the optical fiber 13 may enter into it and may be emitted therefrom in one-dimensional linear form corresponding to the irradiation domain A1. Thus, the near-infrared light L1 shaped into a line in the illuminating section 12 is irradiated from the illuminating section 12 to the irradiation domain A1.

The near-infrared light L1 output from the light source unit 10 is diffuse-reflected by the inspection objects 3 laid on the irradiation domain A1. And a part of the diffuse-reflected light is incident on the detecting unit 20 as diffuse reflection light L2.

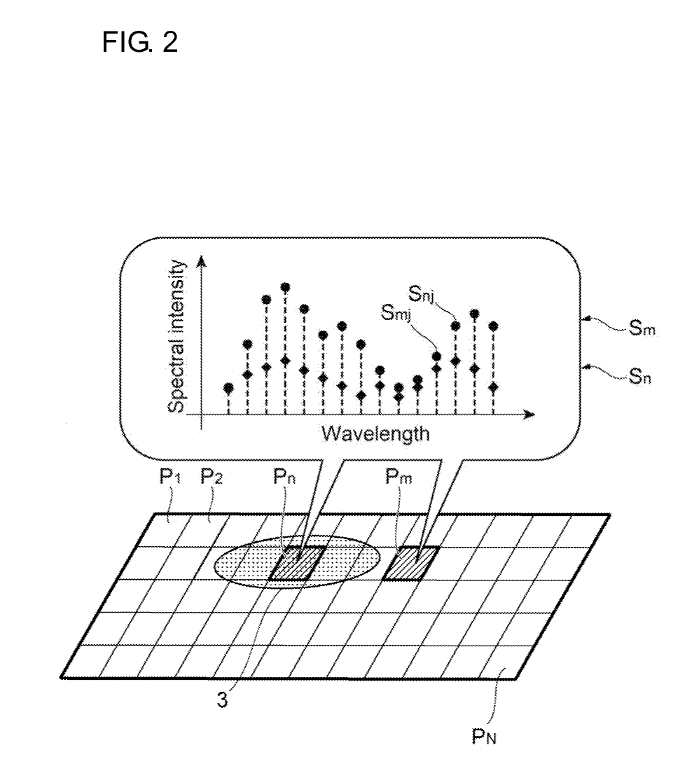

The detecting unit 20 has the function of a hyper-spectrum sensor for acquiring a hyper-spectral image. FIG. 2 is a conceptual diagram explaining a hyper-spectral image detected with the inspection apparatus 100. In the example shown in FIG. 2, the hyper-spectral image is constituted of N number of pixels P₁-P_{N}. FIG. 2 concretely shows two pixels Pₙ and Pₘ. The pixels Pₙ and Pₘ respectively include spectral information Sₙ and Sₘ which consist of a plurality of intensity data. The intensity data shows spectral intensity at a specific wavelength (or wavelength band), and in FIG. 2, fifteen intensity data are held as spectrum information Sₙ and Sₘ, which are shown in a superimposed manner.

Thus, hyper-spectral image H, which has a plurality of intensity data for each pixel constituting an image, is data of three-dimensional composition including both a two-dimensional element as an image and an element as spectral data. In this embodiment, the hyper-spectral image H means an image constituted by pixels which hold intensity data for at least five wavelength bands per pixel.

In FIG. 2, an inspection object 3 is also shown. That is, Pₙ is a pixel which has captured an image of an inspection object 3, and Pₘ is a pixel which has captured an image of the background (for example, a belt conveyor or a carrying container). Thus, the detecting unit 20 can capture an image of a background, as well as an image of an inspection object 3.

Referring back to FIG. 1, the detecting unit 20 has a camera lens 24, a slit 21, a spectrometer 22, and 0/E conversion section 23. The slit 21 is disposed in a direction parallel to the expanding direction (the x-axis direction) of the irradiation domain A1. The diffuse reflection light L2 incident on the slit 21 enters into the spectrometer 22. The spectrometer 22 disperses the diffuse reflection light L2 passed through the slit 21 in the direction (the y-axis direction) perpendicular to the longitudinal direction of the slit 21 (that is, perpendicular to the expanding direction of the irradiation domain A1). The light dispersed by the spectrometer 22 is received by the O/E conversion section 23.

The view domain 20s of the detecting unit 20 is a linear area included in the irradiation domain A1 of the loading side 2b and the diffuse reflection light L2 which has been ejected from the view domain 20s and passed through the slit 21 forms an image on the O/E conversion section 23. The view domain 20s (image capturing area) of the detecting unit 20 extends in the direction (the x-axis direction) perpendicular to the moving direction 2a of the belt conveyor 2.

The O/E conversion section 23 has a light receiving surface on which a plurality of light receiving elements are two-dimensionally arranged, and each light receiving element receives light. Thus, the O/E conversion section 23 receives light of respective wavelength of the diffuse reflection light L2 which has been reflected at each position along the width direction (the x-axis direction) on the belt conveyor 2. Each light receiving element outputs a signal according to the intensity of the received light as information available at one point of two-dimensional plane consisting of a position and a wavelength. The signal outputted from the light receiving element of the O/E conversion section 23 is sent to the analyzing unit 30 from the detecting unit 20 as spectral data for each pixel relating to a hyper-spectral image.

The analyzing unit 30 obtains the spectrum of the diffuse reflection light L2 according to the input signal and evaluates the inspection objects 3 by using the spectral data obtained for each pixel. It is assumed that if an inspection object 3 is a different kind (an article of different kind) as compared with the expected kind or if the inspection object 3 suffer from any change of characteristics, the spectral data obtained from the inspection object 3 in question will differ from the spectral data to be obtained from the originally expected kind of product. Therefore, if a spectral data is analyzed and found to have a different form, the inspection object 3 in question is judged to be different from the expected kind and is classified from the other inspection objects.

The analyzing unit 30 is structured as a computer equipped with a central processing unit (CPU), a random access memory (RAM) and a read only memory (ROM), which are main memories, a communication module for communicating with other apparatus such as a detecting unit, and hardware such as an auxiliary storage, e.g., hard disk. Thus, the operation of these components enables the analyzing unit 30 to accomplish its function. The outline of analyzing process by the analyzing unit 30 and concrete techniques thereof will be described later.

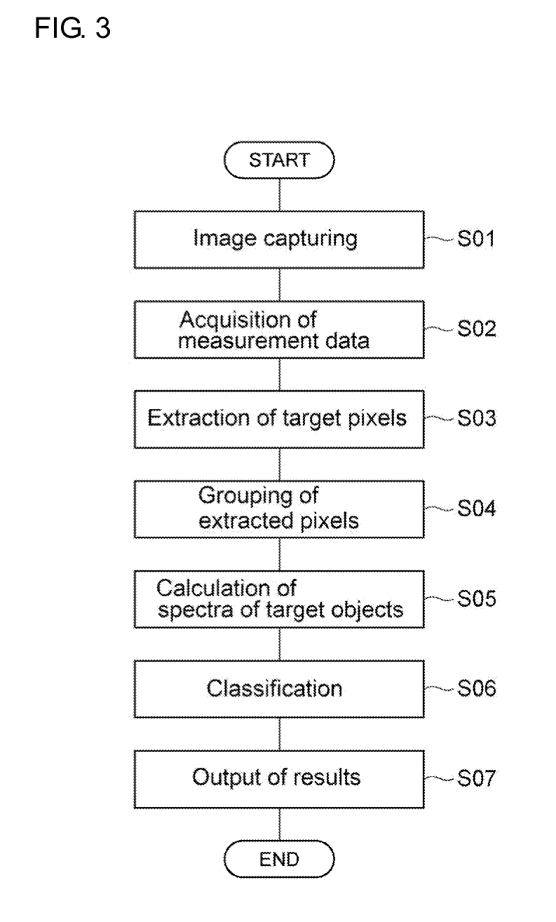

FIG. 3 is a flow chart of the inspection method relating to the embodiment of the present invention. First, near-infrared light L1 is output from the light source unit 10 to the irradiation domain A1 containing the inspection objects 3 which are moving by being laid on the belt conveyor 2, and the detecting unit 20 receives diffuse reflection light L2 including light diffuse-reflected by the inspection objects 3. Thus, the image of view domain 20s (image capturing area) is captured (S01: imaging step).

Next, the spectral data which the detecting unit 20 has obtained for each pixel is sent to and received by the analyzing unit 30 (S02: data acquisition step). In the detecting unit 20, the image-capturing is done continuously corresponding to the movement of the belt conveyor 2, and by accumulating an image thus captured for each view domain in the analyzing unit 30, a hyper-spectral image of the two dimensionally arranged pixels is acquired.

In the analyzing unit 30, of these pixels, those which have captured images of the inspection objects 3, that is, the pixels to be analyzed (target pixels) (S03: pixel extraction step). There are the following three ways for judging as to whether a pixel is a target pixel or not.

In the first method, the judgment as to whether a certain pixel is an target pixel or not is done depending on whether the data of a specific wavelength is within the predetermined threshold value in the spectral data of the pixel concerned. This method is effective in the case where an inspection object 3 contains a specific ingredient when the inspection object 3 and the background are compared with each other.

In the second method, scores are computed using the reflected light intensity data at the first wavelength and the reflected light intensity data at the second wavelength with respect to pixels concerned by performing the four basic arithmetic operations. And the judgment as to whether the pixels concerned are target pixels is done depending on whether the scores are within the predetermined threshold value.

In the third method, spectral data regarding inspection objects, the belt conveyor, and the carrying container are acquired beforehand. And one-dimensional vector data La relating to the spectral data of inspection objects, a belt conveyor, and a carrying container is obtained by using Principal Component Analysis (PCA), which is one of chemometrics, Partial Least Square (PLS) regression analysis, Support Vector Machine (SVM), which exhibits outstanding pattern recognition performance, and the like. Then, using such one-dimensional vector data La and spectral data X for each pixel which has been imaged, score S for each pixel is calculated from expression (1):

S=X·La (1)

and thereby judgment as to whether the scores are within the predetermined threshold value is done.

The above-mentioned SVM, which is a technique for judging the existence of a specific object to be detected, is a well-known discernment algorithm. By learning image data as data for study about samples of two objects to be distinguished, it generates a discernment boundary to them. There are two kinds of SVM: that is, Linear Support Vector Machines (LSVM) in which a discernment boundary is expressed by linear function concerning characteristic value, Kernel Support Vector Machines (KSVM) which is expressed with a nonlinear function. The discernment by LSVM is easy to apply to a real-time operation, since the computation it needs is small. When SVM is used in the analyzing unit 30 of this embodiment, it is possible to conduct analysis with LSVM.

It is advisable to determine beforehand four basic arithmetic operations used for extracting an target pixel, calculation of one-dimensional vector data, and threshold value for judging a target pixel so that a target pixel can suitably be classified. The arithmetic operations and a judgment standard used for extracting a target pixel may be adopted in combination of two or more kinds among a plurality of above-mentioned judgment methods. In the case of using the same judgment method, the operations may be performed a plurality of times, and a plurality of threshold values may be used for a judgment. Also, the operations for the judgment of a target pixel may be performed after processing such as normalization, smoothing, differentiation, etc. is done with respect to the spectral data for each pixel.

Next, grouping is performed with respect to extracted target pixels (S04: grouping step). In a case where an inspection object 3 is a tablet, for example, grouping is performed for the purpose of making a group of the target pixels that are conjectured to have imaged the same tablet, since it is presumed that a piece of tablet is imaged by a plurality of pixels.

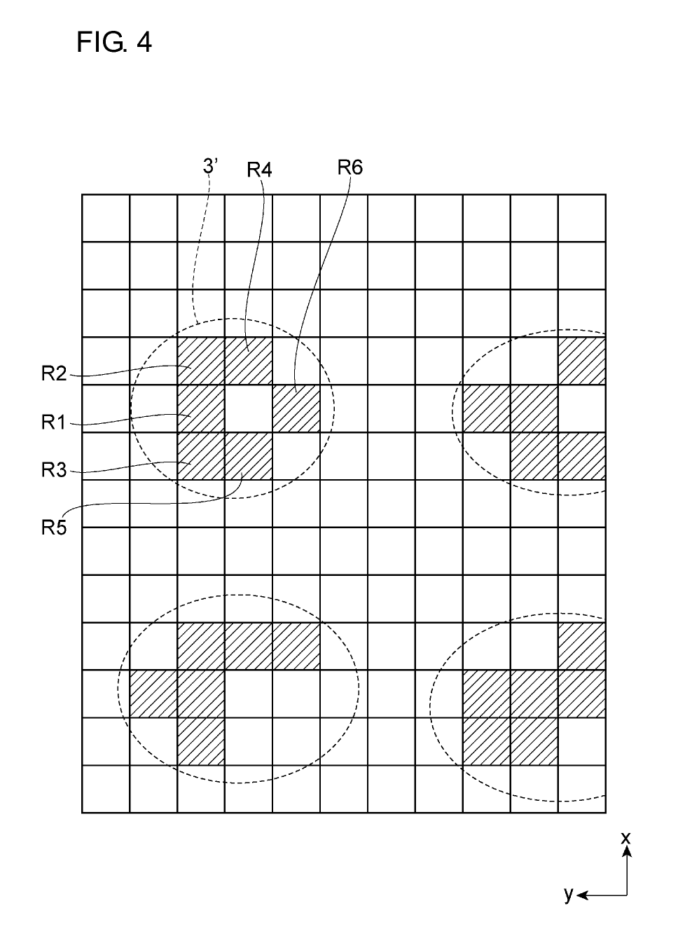

In FIG. 4, which is a conceptual diagram explaining a first example of grouping of target pixels, the pixels acquired in the detecting unit 20 are shown in two dimensional arrangement. Of the pixels, those that are judged to be target pixels in the pixel extraction step (S03) are indicated with slash lines.

In the first example, a pixel contained in a given range having a specific pixel centered therein is judged to belong to the same group as the specific pixel concerned. Assuming that the given range is 3 pixels (X direction)×3 pixels (Y direction) including pixel R1 as its center, pixels R2 to R5 are considered to belong to the same group because they belong to the range of 3 pixels×3 pixels containing pixel R1. Further, assuming on basis of pixel R4 (or pixel R5) contained in the group concerned, pixel R6 will also be judged to belong to the same group. When each of pixels R1 to R6 is considered as a center, there are no target pixels contained in a range of 3 pixels×3 pixels other than pixels R1 to R6, and therefore pixels R1 to R6 are judged to belong the same group. That is, they are judged to be target pixels relating to the same inspection object 3′. By repeating grouping work in such manner, the target pixels that have imaged the same inspection object can be classified into the same group respectively.

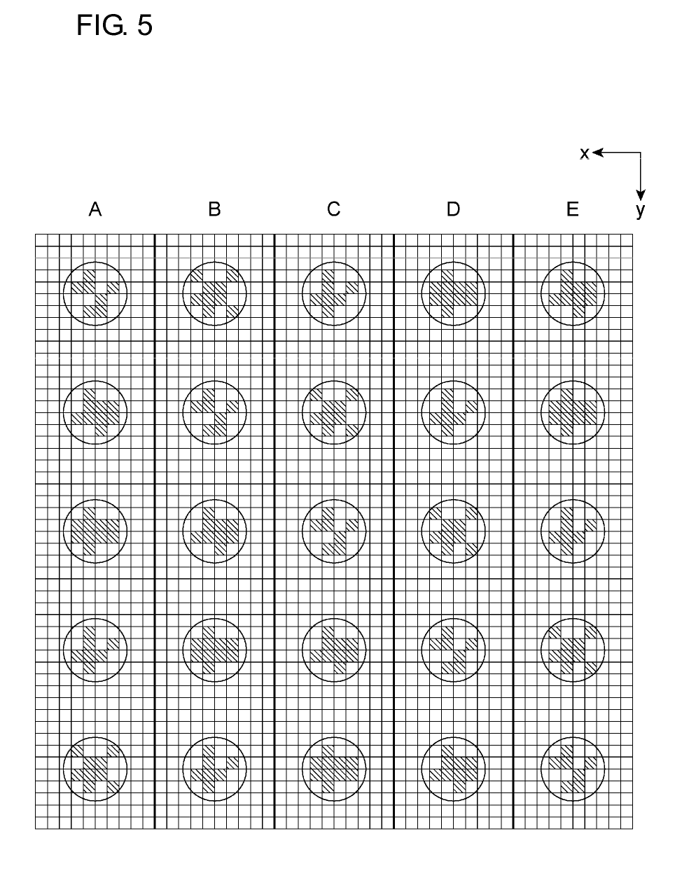

FIG. 5 is a conceptual diagram explaining a second example of grouping of target pixels. In the second example, a plurality of pixels arranged in a two-dimensional manner are divided beforehand into a plurality of areas (A, B, C, . . . ) along the conveyance direction (y direction). And, regarding the direction (x direction) which is perpendicular to the conveyance direction, all of the target pixels that exist in the same area are judged to belong to the same group. As to the conveyance direction, judgment is done in a similar manner as the first example: target pixels contained in a given range on which a target pixel centers are judged to belong to the same group as the target pixel concerned.

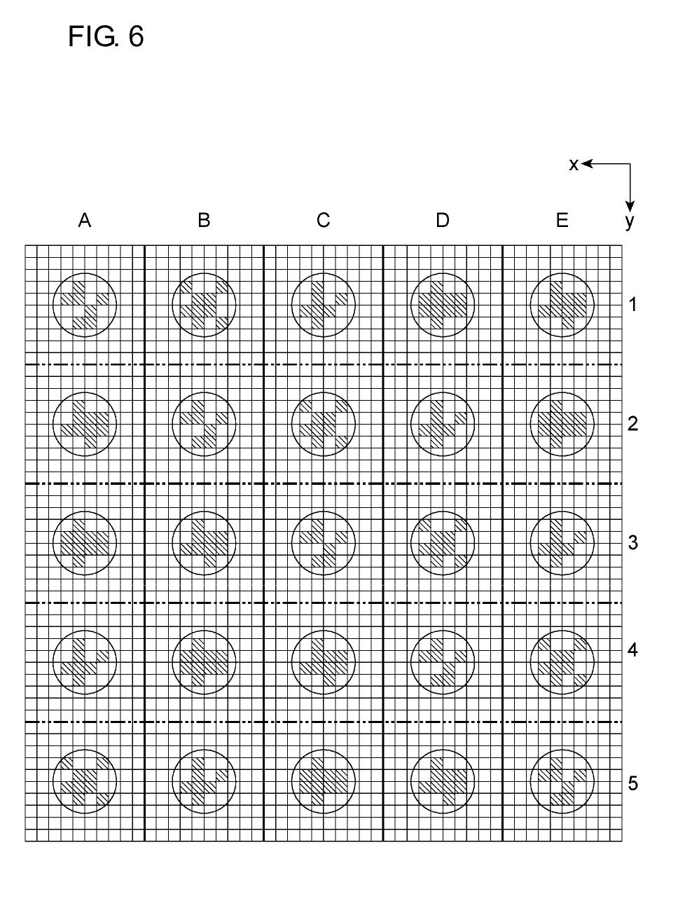

FIG. 6 is a conceptual diagram explaining a third example of grouping of target pixels. In the third example, a plurality of pixels which are arranged in a two-dimensional manner are divided beforehand into a plurality of areas (A1, A2, A3, . . . , B1, B-2, B3, . . . , C1, C2, C3, . . . ). And, all of the target pixels that exist in the same area are judged to belong to the same group. The method of grouping is not limited to the above, and it may be changed in a suitable manner as needed.

On the basis of spectral data of target pixels which are grouped by extracting in this way, calculation of the spectrum of an inspection object is performed (S05: spectrum calculation step). The calculation of the spectrum of an inspection object means computing one spectral data on the basis of the spectral data of pixels contained in the same group. In this process, the calculation of spectral data of inspection objects is performed in a suitable manner selected from the following.

### Averaging Process Along Spatial Coordinate

The average value of reflected light of each wavelength is calculated by using the total of the spectral data of grouped target pixels. Such processing enables obtaining spectral data on the basis of average value of reflected light at a plurality of points of a target object, instead of reflected light at only one point of the target object.

### Normalizing Process

Normalizing process is accomplished by performing at least any of the following processes (A) to (E) for spectral data. These processes may be done using total of the spectral data of each pixel before the above-mentioned averaging process along spatial coordinate, and the normalizing process may be performed after the below-mentioned smoothing process.

(A) The spectral data of a standard target object (a material having uniform reflectance in a near-infrared wavelength band) is measured as a white value beforehand, and the spectral data of an inspection object is divided by the white value (white level correction).

(B) The spectral data imaged in the dark state is measure as a black level value beforehand, and the black level value is subtracted from the spectral data (black level correction).

(C) Of the spectral data, the intensity of a wavelength having minute sensitivity is defined as a pseudo black level value, and the pseudo black level value is subtracted from the spectral data (pseudo black level correction). The intensities of a plurality of wavelengths may be averaged to establish the pseudo black level value.

(D) After the black level value or the pseudo black level value is subtracted from the spectral data, the value thereby obtained is divided by the value obtained by subtracting the black level value or the pseudo black level value from the white level value (black level/white level correction).

(E) After the average value over the all of wavelength elements in a spectral data is subtracted from the each wavelength element, the value thereby obtained is divided by the standard deviation of the spectral data over the all of wavelength elements, and thereby the influence of variation of intensity between the respective spectral data is eliminated (SNV).

### Smoothing Process

Of the spectral data of a target object, a moving average or a weighted moving average of reflectance at a plurality of neighboring wavelengths is obtained, and thereby the influence of a minute noise contained in a spectrum waveform is decreased.

### Differentiation Processing/First Order Derivative, or Second Order Derivative

In order to emphasize the absorption peak of spectral data, first order derivative or second order derivative is sought. Moreover, in order to decrease the influence of noise, smoothing over several points to tens of points is done. For computing, a Savitzky-Golay method may be used, for example.

By performing processing as shown above, the spectral data of a target object used for a classification of inspection objects 3 can be extracted from the spectral data of a plurality of pixels contained in the same group.

Next, on the basis of the computed spectral data of the inspection objects, the classification, that is, judgment as to whether each inspection object 3 is an article of different kind or a defective article is performed (S06: classification step). In the case of such judgment, it is possible to adopt a judging method similar to that used at the time of calculation of target pixels: that is, in spectral data, four basic arithmetic operations are performed with respect to the data of a certain wavelength and the data of another wavelength to calculate a score, judgment is done depending on whether the score is more than a threshold value or not. It is also possible to adopt a judging method in which score calculation is performed by conducting calculation shown with expression (1) using one-dimensional vector data and judgment is done according to whether the score thus obtained is more than the threshold value or not. As in the case of extracting a target pixel, a plural kinds of one-dimensional vectors PCA, PLS, and SVM may co-exist, and also a plurality of one-dimensional vectors may be used in one kind of analysis technique.

In the case where inspection objects are classified into not only two kinds (e.g., good articles and defective articles) but also three or more kinds, for example, it may be impossible to accomplish identification with only one judgment condition. In such case, judgment may be performed a plurality of times by conditional branching process. The conditional branching process is a processing method in which only a specific kind of items are detected with the first time judgment conditions, and the rest of items are judged under judgment conditions which are different from the first time judgment conditions. Repeating such judgment process makes it possible to perform plural kinds of classifications.

Finally, the results of judgment as to whether the objects concerned are articles of different kind or defective quality are output to the outside by a monitor (S07: result-outputting step). With the processes mentioned above, the inspection method using the inspection apparatus 100 is completed. Note that the processes such as imaging (S01), acquisition of measurement data (S02), and extraction of target pixels (S03) can be performed for every imaging of one line by the detecting unit 20. As for the remaining processes such as (S04) to (S07), since they are carried out after collection of information on related pixels, it is desirable that the spectral data for each pixel be buffered by more than a predetermined number in the analyzing unit 30.

Here, an example of application of the present invention is shown, where six kinds of tablet items (A, B, C, D, E, F) put in a carrying container (six rows) are used as inspection objects. The detecting unit 20 of the inspection apparatus used in the example includes a two-dimensional spectrometer made by Specim in Finland and a near-infrared camera made by Sumitomo Electric Industries, Ltd.

First, in order to compute one-dimensional vector data for score calculation process, a hyper-spectral image was acquired using 500 doses of tablets for each item as inspection objects under the conditions of the focal length f=30.7 mm of a lens used and a wavelength of 1120 to 2270 nm for statistical work.

Thereafter, after performing the white black level correction regarding the spectral data obtained for each pixel by imaging the tablets which are inspection objects placed in the carrying container, pixels were extracted as target pixels, provided that they satisfy all of six conditions: [0.3052<reflectance at 1168 nm<1], [0.3052<reflectance at 1369 nm<1], [0.3052<reflectance at 1594 nm<1], [0.2442<reflectance at 2131 nm<1], [reflectance at 1369 nm/reflectance at 1594 nm>0.5], and [reflectance at 1168 nm/reflectance at 2131 nm>1.0].

Next, grouping process was performed with respect to the extracted target pixels such that the neighboring pixels were grouped as the same group. The condition for grouping as the same group at that time was that if there were 9 target pixels or more within an area of 5 pixels (conveyance width direction, that is X direction)×5 pixels (conveyance direction, that is Y direction), those pixels were judged to belong to the same group.

Next, the averaging of the spectral data of the respective pixels thus grouped was performed after the SNV process. And a second order derivative was computed with respect to the spectral data of the obtained average. As for the second order derivative, the Savitzky-Golay method was used and the calculation was done using seven values including three points available in both directions at a specific point. By performing the above-mentioned processing, the spectrum of a target object was acquired for each tablet to be classified.

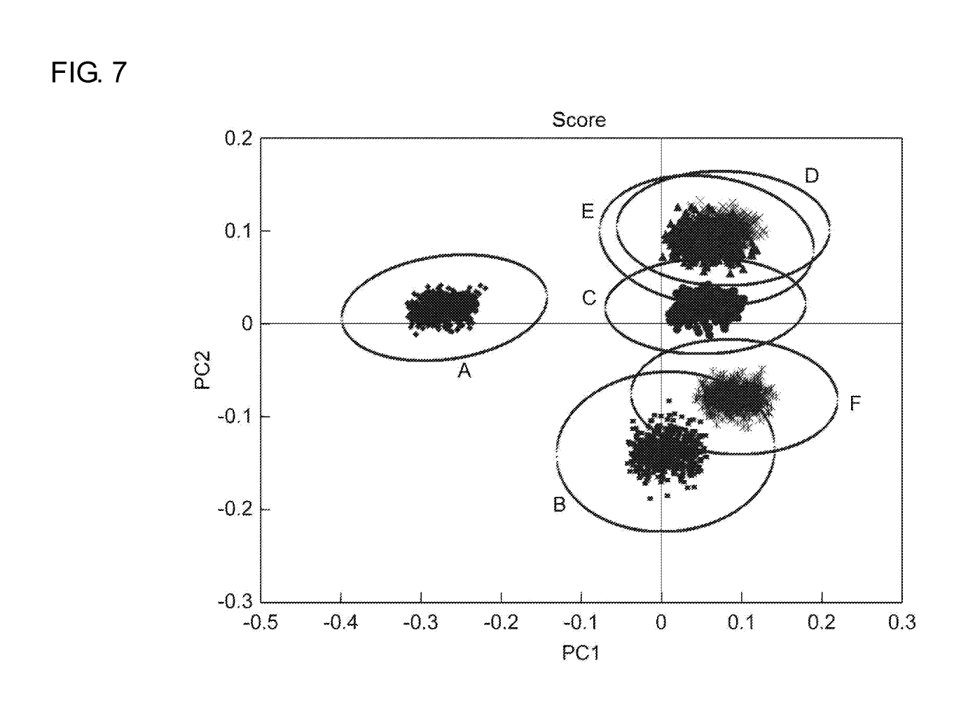

On the other hand, three one-dimensional vector data (PC1, PC2, PC3) were obtained on the basis of the spectral data of all the target pixels of items A to F by the PCA. The results of computing the score of the spectral data of a target object for the respective tablets are shown in FIG. 7 by adopting two one-dimensional vector data (PC1 and PC2). As shown in FIG. 7, it was confirmed that in the case where PC1 and PC2 were used, item A was clearly discriminable since the domain A did not have any duplication with the other domains B to F.

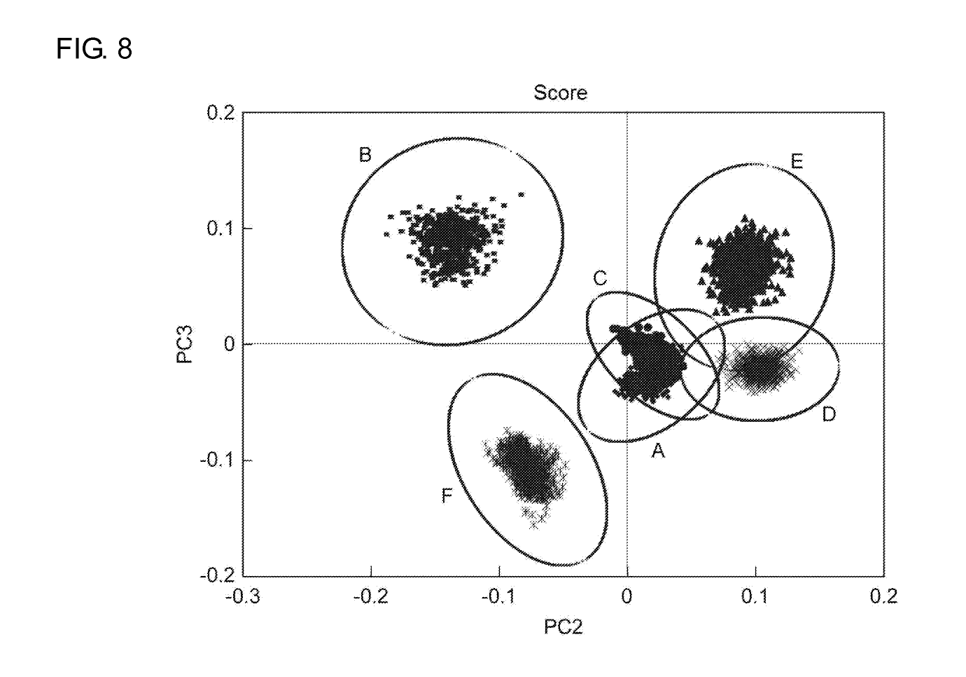

Next, the scores of spectral data of target objects of the respective tablets relating to items B to F were computed by adopting two one-dimensional vector data (PC2 and PC3). The results of the computation are as shown in FIG. 8. In this case, it was confirmed that the items B and F were clearly discriminable by this analysis since the domains B and F did not overlap with the other domains C to E.

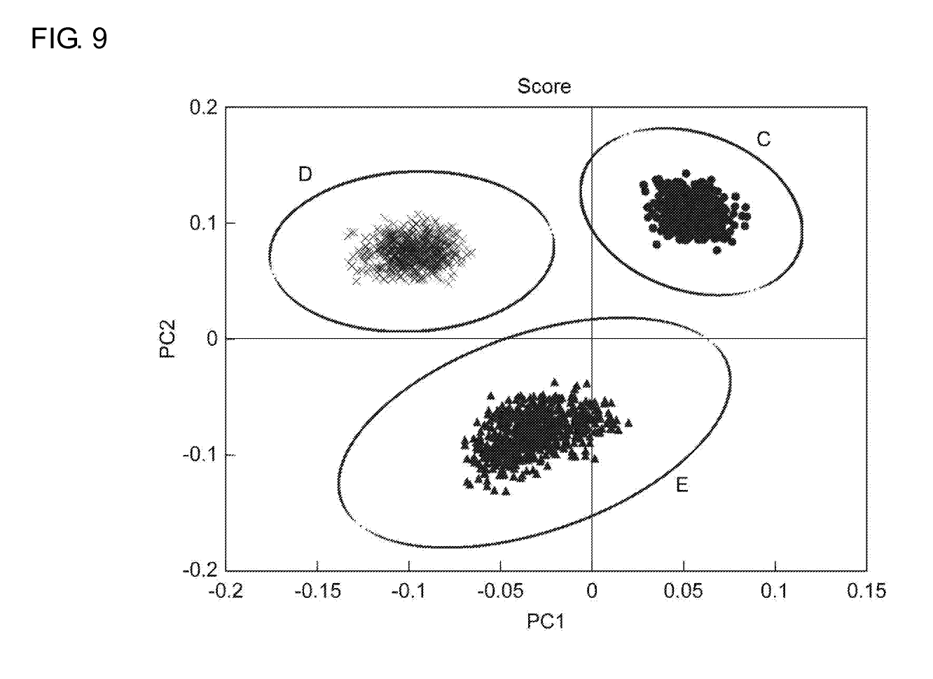

Furthermore, if there are items C to E which are difficult to discriminate, it is advisable to add another judgment condition by using conditional branching process. More specifically, when two one-dimensional vector data (PC1, PC2) are adopted by PCA on the basis of the spectral data (the horizontal axis is a wavelength axis) of items C to E, and the scores of spectral data of target objects of the respective tablets are computed, the results of such computation are as shown in FIG. 9. In FIG. 9, it was confirmed that since the domains C to E did not have any duplication, the items C to E were clearly discriminable by this analysis.

Thus, it was confirmed that all of the items A to F were discriminable by two kinds of PCA. That is, it has been confirmed that a plural kinds of items can be classified by performing judgment a plurality of times using conditional branching process. In the above-mentioned example, when the domains A to F are specified, the size of each domain was set as 6 times of the standard deviation of a score, but the size of a domain is not limited to this.

Moreover, although one-dimensional vector data was computed using PCA in the above, it is also possible to compute by PLS or SVM instead of PCA, properly selecting any of them depending on a target object. Also, in the case where there are clear differences in spectral shapes among inspection objects, it is possible to adopt a simple judgment condition using four mathematical operations, without using linear combination by one-dimensional vector data.

As described above, according to the inspection apparatus 100 relating to the present invention and the inspection method using the inspection apparatus 100, first, target pixels which include an image of inspection object are extracted from the acquired spectral data of the respective pixels, and the spectral data of plural target pixels which have imaged the same inspection object are grouped beforehand, and the classification of inspection objects is performed using the thus grouped spectra of the target objects. Therefore, the classification of inspection objects is done using the spectral data of a plurality of target pixels which have imaged the same inspection object, and it enables detecting articles of different kind or defective quality with higher accuracy, reducing the possibility of incorrect judgment due to a noise contained in a specific pixel.

Moreover, pixels contained in a predetermined range having a specific pixel centered therein are judged to belong to the same group, and thereby grouping is done for a plurality of pixels. Therefore, grouping of target pixels conjectured to have imaged the same inspection object can be accomplished with a simpler method. Thus, it is made possible to more simply conduct high-precision detection for articles of different kind or defective articles.

Also, in the above-mentioned inspection method, it is possible to finish one processing in tens of microseconds, for example, since the computational complexity of algorithm used for classification in the analyzing unit 30 is small, resulting in short time-cycle needed for calculation processing. Therefore, even if judgment processing is repeated many times by performing conditional branching process, the above-mentioned purpose can be attained sufficiently in a short time. Of the above-mentioned processing, the averaging process along spatial coordinate is performed after extraction of target pixels; however, other processes (correction process, normalization process, etc.) are applicable to the spectral data of each pixel.

What is claimed is:

1. An inspection apparatus for classifying inspection objects in an image capturing area, comprising:
a light source for emitting near-infrared light to the image capturing area;
dispersing means for dispersing the light incident from the image capturing area when the near-infrared light is emitted;
imaging means for outputting spectral data of each pixel by capturing a spectral image consisting of a plurality of pixels of light dispersed by the dispersing means;
pixel extraction means for extracting, on the basis of the spectral data of each pixel, a target pixel to be analyzed from a plurality of pixels;
spectrum calculation means for calculating the spectrum of inspection objects on the basis of spectral data of target pixels classified as belonging to a group formed by grouping a plurality of target pixels lying adjacent to each other; and
a classifying means for classifying inspection objects on the basis of the spectrum computed by the spectrum calculation means.

2. An inspection apparatus as set forth in claim 1, wherein the spectrum calculation means classifies a plurality of pixels into the same group with a specific pixel if the plurality of pixels are judged to lie in a predetermined range having the specific pixel centered therein.

3. An inspection method, comprising:
a dispersing step for dispersing the light incident from an image capturing area when near-infrared light is emitted thereto by a light source;
an imaging step for outputting spectral data of each pixel by capturing a spectral image consisting of a plurality of pixels of light dispersed at the dispersing step;
a pixel extraction step for extracting, on the basis of the spectral data of each pixel, a target pixel to be analyzed from a plurality of pixels;
a spectrum calculation step for calculating the spectrum of inspection objects on the basis of spectral data of target pixels belonging to each group formed by grouping a plurality of target pixels lying adjacent to each other; and
a classifying step for classifying inspection objects on the basis of the spectrum computed by the spectrum calculation step.
